(19) United States
(12) Patent Application Publication
(10) Pub. No.: US 2026/0287896 A1
(43) Pub. Date: Sep. 24, 2026

(54) WAVEGUIDE WITH EMBEDDED LEAKY IMAGE PIPE

(71) Applicant: LUMUS LTD., NESS ZIONA (IL)

(72) Inventors: Tsion EISENFELD, Ness Ziona (IL); Jonathan GELBERG, Ness Ziona (IL)

(73) Assignee: LUMUS LTD., NESS ZIONA (IL)

(21) Appl. No.: 19/475,942

(22) PCT Filed: Jul. 28, 2023
(86) PCT No.: PCT/IB2023/057692

§ 371 Date: Oct. 16, 2025

Related U.S. Application Data
(60) Provisional application No. 63/459,727, filed on Apr. 17, 2023.

(51) Int. Cl. G02B 27/01

(52) U.S. Cl. CPC G02B 27/0172; G02B 27/0176; G02B 2027/0125; G02B 2027/015; G02B 2027/0178

(57) ABSTRACT

An optical device may include a waveguide having a front surface and a parallel rear surface; a first aperture expander configured to receive an input image beam and provide a first plurality of expanded image beams, the first plurality of expanded image beams configured to propagate and reflect between the front and rear surfaces; a leaky image pipe configured to receive a first portion of the first plurality of expanded image beams and provide a plurality of transmitted image beams, the first portion of the first plurality of expanded image beams configured to partially reflect within the leaky image pipe; and a second aperture expander within the waveguide and configured to receive a second portion of the first plurality of expanded image beams and the plurality of transmitted image beams, the second aperture expander configured to provide a second plurality of expanded image beams configured to exit through the rear surface.

### CROSS-REFERENCE TO RELATED APPLICATION

This application is based upon and claims the benefit of priority under 35 USC 119(e) of U.S. Patent Application No. 63/459,727 filed on Apr. 17, 2023, and titled Embedded Light Guiding Slab, the entire disclosure of which is incorporated herein by reference in its entirety.

### BACKGROUND

Unless otherwise indicated herein, the materials described in this section are not prior art to the claims in this application and are not admitted to be prior art by inclusion in this section.

The present disclosure relates in general to optical devices and systems related to wearable devices for use in augmented reality applications, more particularly, to an improved wearable device for providing optical information directly to a user.

Wearable optical devices, such as near eye displays or smart glasses for use in augmented reality applications, are often cumbersome to wear and use, thus limiting their comfort and utility. Current wearable optical devices may also have a limited field-of-view (FoV) which can be undesirable for a user and could affect safety in some situations. However, increasing the field-of-view usually requires pushing the limits of geometric boundaries, which can be expensive and can lead to a product form factor and/or aesthetic appearance which may not be acceptable in the marketplace. What is needed is a solution that addresses these issues, and others.

### SUMMARY

According to an example, an optical device is generally described. The optical device may include a waveguide having a front surface and a rear surface that are parallel to each other; a first aperture expander disposed within the waveguide and configured to receive an input image beam coupled by internal reflection and provide a first plurality of expanded image beams, the first plurality of expanded image beams configured to propagate and reflect between the front surface and the rear surface; a leaky image pipe disposed within the waveguide and configured to receive a first portion of the first plurality of expanded image beams and provide a plurality of transmitted image beams, the first portion of the first plurality of expanded image beams configured to partially reflect within the leaky image pipe; and a second aperture expander disposed within the waveguide and configured to receive a second portion of the first plurality of expanded image beams and the plurality of transmitted image beams, the second aperture expander configured to provide a second plurality of expanded image beams configured to exit through the rear surface.

According to this example, the optical device wherein the leaky image pipe includes an input face, an output face, and an inner surface wherein one of: the inner surface has a continuously progressive transmissive coating in a direction from the input face to the output face; the inner surface has a discretely progressive transmissive coating in a direction from the input face to the output face; and the inner surface has a uniformly transmissive coating. The optical device wherein the first aperture expander may include a first plurality of partially reflecting facets that are inclined at an angle and that are one of: oblique relative to at least one of the front surface and a plane that is perpendicular to the front surface; and perpendicular to the front surface. The optical device wherein the input image beam is injected into the waveguide at a coupling region and propagates through the first aperture expander in a first direction away from the coupling region, and wherein at least one of: a reflectivity of the first plurality of partially reflecting facets increases in a direction away from the coupling region; a reflectivity of the first plurality of partially reflecting facets is constant in a direction away from the coupling region; the first aperture expander has a terminal facet that is a partially reflecting facet; and the first aperture expander has a terminal facet that is a mirror. The optical device wherein the leaky image pipe is an elongated member having orthogonal sides and a rectangular cross section, and wherein the leaky image pipe has an outer surface that is at least one of: aligned perpendicular to the front surface; aligned non-perpendicular to the front surface; and aligned at an angle with a horizontal axis. The optical device the leaky image pipe may further include an outer surface with a mirror disposed on a side of the leaky image pipe opposite the second aperture expander.

According to this example, the optical device leaky image pipe may further include an outer surface; and an input face configured to receive the first portion of the first plurality of expanded image beams, the input face being perpendicular to the front surface and inclined at an angle relative to the outer surface that ranges between 20° and 160°. The optical device wherein the leaky image pipe is a first leaky image pipe, the plurality of reflected image beams is a first plurality of transmitted image beams transmitted through a first inner surface directed toward the second aperture expander, and the input face is a first input face, the optical device may further include: a second leaky image pipe disposed within the waveguide on a side of the second aperture expander opposite the first leaky image pipe, the second leaky image pipe configured to receive a third portion of the first plurality of expanded image beams and provide a second plurality of transmitted image beams through a second inner surface directed toward the second aperture expander, wherein the second aperture expander is configured to receive the first plurality of transmitted image beams, the second plurality of transmitted image beams, and the second portion of the first plurality of expanded image beams and provide a second plurality of expanded image beams configured to exit through the rear surface.

According to this example, the optical device wherein at least one of the first leaky image pipe and the second leaky image pipe are disposed at an angle with a horizontal axis of the waveguide. The optical device wherein the second aperture expander comprises a second plurality of partially reflecting facets that are inclined at an angle that is oblique relative to at least one of the front surface and a plane that is perpendicular to the front surface. The optical device wherein the second portion of the first plurality of expanded image beams and the plurality of reflected image beams are directed to an eye motion box. The optical device wherein the waveguide further comprises a partial plane reflector as a first homogenizing layer disposed in a plane between the front surface and the rear surface. The optical device wherein the leaky image pipe further comprises a second homogenizing layer disposed in a plane between the front surface and the rear surface of the leaky image pipe. The optical device wherein the leaky image pipe further comprises a third homogenizing layer disposed in a plane between an inner surface and an outer surface of the leaky image pipe. The optical device wherein the leaky image pipe further comprises a fourth homogenizing layer having a first portion that is disposed between the first aperture expander and the second aperture expander, the fourth homogenizing layer having a second portion disposed between the leaky image pipe and the second aperture expander. The optical device may further include an image projector configured to produce a collimated image beam based on a digital image, wherein the collimated image beam is collimated to infinity; an input coupler configured to receive an input image beam and provide an output image beam that is injected into the waveguide at a coupling region; and a fifth homogenizing layer disposed between the image projector and the input coupler,

According to another example, an optical system is generally described. The optical system may include a waveguide having a front surface and a rear surface that are parallel to each other; an image projector configured to produce a collimated image beam based on a digital image, wherein the collimated image beam is collimated to infinity; an input coupler configured to receive the collimated image beam and output an input image beam that is injected into the waveguide at a coupling region; a first aperture expander disposed within the waveguide and configured to receive an input image beam and provide a first plurality of expanded image beams, the first plurality of expanded image beams configured to propagate and reflect between the front surface and the rear surface; a leaky image pipe disposed within the waveguide and configured to receive a first portion of the first plurality of expanded image beams and provide a plurality of transmitted image beams, the first portion of the first plurality of expanded image beams configured to partially reflect within the leaky image pipe, the leaky image pipe being an elongated member having orthogonal sides and a rectangular cross section; and a second aperture expander disposed within the waveguide and configured to receive a second portion of the first plurality of expanded image beams and the plurality of reflected image beams, the second aperture expander configured to provide a second plurality of expanded image beams configured to exit through the rear surface.

According to this example, the optical system wherein the leaky image pipe includes an input face, an output face, and an inner surface wherein one of: the inner surface has a continuously progressive transmissive coating in a direction from the input face to the output face, the inner surface has a discretely progressive transmissive coating in a direction from the input face to the output face; and the inner surface has a uniformly transmissive coating. The optical system wherein the first aperture expander comprises a first plurality of partially reflecting facets that are inclined at an angle that is one of: oblique relative to at least one of the front surface and a plane that is perpendicular to the front surface; and perpendicular to the front surface; and wherein the second aperture expander comprises a second plurality of partially reflecting facets that are inclined at an angle that is oblique relative to at least one of the front surface and a plane that is perpendicular to the front surface. The optical system wherein the leaky image pipe may further include an outer surface with a mirror disposed perpendicular to the front surface, the outer surface and mirror being disposed on a side of the leaky image pipe opposite the second aperture expander; and an input face configured to receive the first portion of the first plurality of expanded image beams, the input face being perpendicular to the front surface and inclined at an angle relative to the outer surface that ranges between 20° and 160°.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 illustrates a block diagram of an optical system, in accordance with various examples of the present disclosure.

FIG. 2A illustrates a front plan view of an optical system including a waveguide, in accordance with various examples.

FIG. 2B illustrates a side plan view of an optical system including the waveguide of FIG. 2A, in accordance with various examples.

FIG. 3A illustrates a front plan view of an optical system including a waveguide, in accordance with various examples.

FIG. 3B illustrates a side plan view of an optical system including the waveguide of FIG. 3A, in accordance with various examples.

FIG. 4 illustrates a front plan view of an optical system including a waveguide, in accordance with various examples.

FIG. 5 illustrates a front plan view of an optical system including a waveguide, in accordance with various examples.

FIG. 6 illustrates a front plan view of an optical system including a waveguide, in accordance with various examples.

FIG. 7 illustrates a front plan view of an optical system including a waveguide, in accordance with various examples.

FIG. 8 illustrates a front plan view of an optical system including a waveguide, in accordance with various examples.

FIG. 9 illustrates a front plan view of an optical system including a waveguide, in accordance with various examples.

FIG. 10 illustrates a front plan view of an optical system including a waveguide, in accordance with various examples.

FIG. 11 illustrates a front plan view of an optical system including a waveguide, in accordance with various examples.

FIG. 12 illustrates a front plan view of an optical system including a waveguide, in accordance with various examples.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

To be described in more detail below, a wearable device, such as a near eye display and/or smart glasses, can be implemented by a system and method described in accordance with the present disclosure. The system can efficiently provide high quality optical information to a user in various applications.

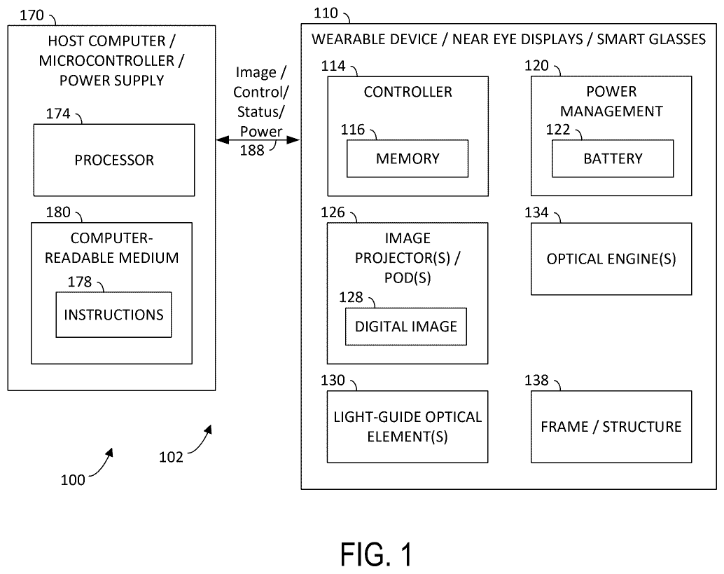

FIG. 1 illustrates a block diagram of an optical system, in accordance with various examples of the present disclosure. Optical system 100 may include two or more devices or components. Optical system 100 may be implemented generally as a hybrid system including various electronic, optical, and electro-optical elements. An optical device 102 may include one or more elements from optical system 100. To be described in more detail below, an optical system 100 may include a wearable device 110, such as one or more near eye displays or smart glasses, which may be worn on or about the head of a user to convey optical information to one or more eyes of a user.

Wearable device 110 may include a controller 114 with a memory 116 where controller 114 may be configured to send and receive electrical signals to various other elements in optical system 100, to execute program instructions stored in memory 116 in order to process and provide information, to operate wearable device 110, and to interact with other systems outside wearable device 110, for example. Controller 114 may include a microcontroller, a processor, various discrete components, programmable logic devices, and/or various interface circuits that may access memory 116 which may be removable, replaceable, programmable, and reprogrammable to update instructions to controller 114.

Wearable device 110 may also include a power management module 120 having a battery 122, where power management module 120 may be configured to charge, discharge, and monitor power usage for battery 122. Various elements of wearable device 110 may receive power from battery 122, including controller 114, image projector 126, and optical engine 134, for example. Wearable device 110 may also include one or more image projectors 126, each configured to produce a collimated image beam based on a digital image 128. The collimated image beam may be an illuminated representation of the digital image having an image field which is a two-dimensional representation of the digital image based on either a single graphical image (e.g., a static image) or a sequence of graphical images (e.g., a moving image). The collimated image beam may be collimated to infinity.

Wearable device 110 may also include one or more waveguides 130 (e.g., WGs, also denoted as light-guide optical elements LOEs) comprising transparent materials configured to receive and propagate light, where light may enter into and exit through various external and internal surfaces of waveguide 130. For example, the transparent material comprising waveguide 130 may include optical glass or other suitable material that is transformed into complex optical structures using a process that may include coating, stacking, slicing, polishing, and shaping the transparent materials. The process may include the addition of partially reflective or fully reflective materials such as mirror coatings, for example. Similarly, the process may also include the addition of partially opaque or fully opaque materials such as light covers to block light, for example.

Wearable device 110 may also include one or more optical engines 134 coupled to the one or more image projectors 126 and waveguides 130. Optical engine 134 may be configured to directly operate image projector 126 under the direction of the controller 114. For example, optical engine 134 may provide graphics processing for digital image 128 before projection of an illuminated representation of the digital image by image projector 126.

Wearable device 110 may also include a frame 138 (e.g., a structure) for supporting and retaining one or more elements in wearable device 110. For example, frame 138 may support and retain a first image projector 126 in position next to a first waveguide 130. Similarly, frame 138 may support and retain a second image projector 126 in position next to a second waveguide 130. In this manner, frame 138 may support and retain one or two image projectors 126 and waveguide 130 pairs on or about the head of a user, for example. References are made herein regarding the orientation of various elements relative to each other. such references may also include reference to various elements of wearable device 110 when supported by frame 138 or in reference to a three-dimensional (3D) reference (e.g., X, Y, Z axes), as described in the relevant drawing figure.

Optical system 100 may also include a host computer 170 that may include a processor 174 configured to read and execute operations based on instructions 178 stored in a computer-readable medium 180. Instructions 178 may include at least some instructions provided to controller 114 and stored in memory 116. Host computer 170 may communicate with one or more elements of wearable device 110 over a signal and power bus 188. In this manner, host computer 170 may provide power to charge battery 122, provide instructions to and receive status from controller 114, to control various other elements of wearable device 110, and to provide digital image data to optical engine 134.

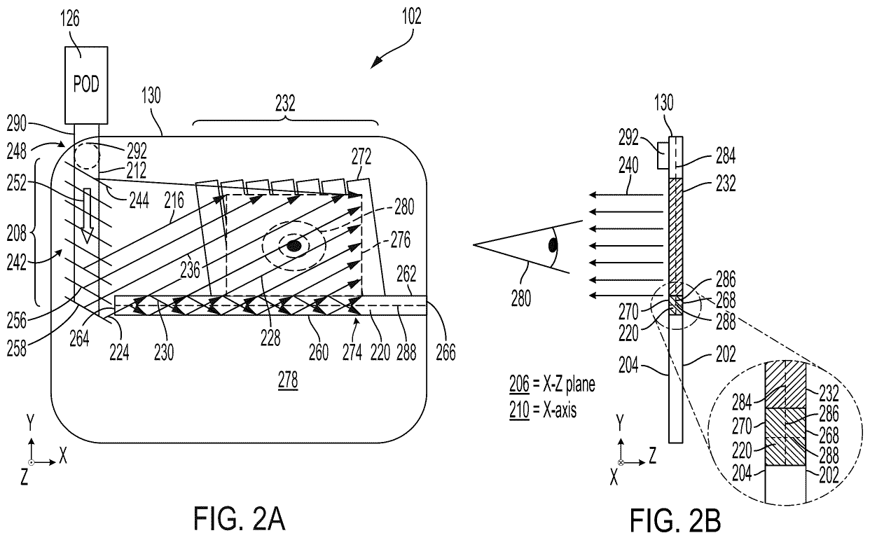

FIG. 2A illustrates a front plan view of an optical system including a waveguide, in accordance with various examples. FIG. 2B illustrates a side plan view of an optical system including the waveguide of FIG. 2A, in accordance with various examples. With further reference to FIG. 1 and FIGS. 2A-2B, together these illustrate an optical system 100 (with an optical device 102) in a first configuration that may include a waveguide 130 (WG 130) having a front surface 202 and a rear surface 204 that are parallel to each other. An image projector 126 may be configured to produce a collimated image beam 290 based on a digital image 128, where the collimated image beam may be collimated to infinity. The collimated image beam may be an illuminated representation of the digital image having an image field which is a two-dimensional representation of the digital image based on either a single graphical image (e.g., a static image) or a sequence of graphical images (e.g., a moving image). An input coupler 292 may be configured to receive collimated image beam 290 and output an input image beam 212 that is injected into waveguide 130 at a coupling region 248. Although FIG. 2A illustrates a gap between image projector 126 and input coupler 292, such a gap is for illustrative purposes and no gap may exist in an actual implementation, for this example and others.

A first aperture expander 208 may be disposed within waveguide 130 and configured to receive input image beam 212 coupled by internal reflection and provide a first plurality of expanded image beams 216 expanded in a first dimension. First plurality of expanded image beams 216 may be configured to propagate and reflect between front surface 202 and rear surface 204 (e.g., external surfaces). First aperture expander 208 may include a first plurality of planar, mutually-parallel and partially reflecting optical elements 242 (e.g., facets, or internal surfaces) that are inclined at an angle that is one of: oblique relative to at least one of front surface 202 and a plane 206 (e.g., an X-Z plane) that is perpendicular to the front surface, and perpendicular (e.g., plane 206) to the front surface. As will be described more fully below, various coupling arrangements for input image beam 212 may be used, including a mirror, an optical coupler, and other mechanisms. Stated more generally, input image beam 212 may be coupled into waveguide 130 (e.g., a substrate) and first aperture expander 208 by internal reflection.

As described, partially reflecting may mean partially transmitting so that some portion of the illumination incident on a particular facet may be reflected while the remaining portion may be transmitted through the facet, resulting in a first set of planar, mutually-parallel and partially reflecting facets 242 starting from an initial facet 244 at a beginning of and continuing through to a penultimate facet 256 and an ultimate (e.g., terminal) facet 258 at the end of first aperture expander 208 where illumination travels in a direction 252 along first aperture expander 208 from initial facet 244 to terminal facet 258. Thus, input image beam 290 may be injected into waveguide 130 at a coupling region 248 and propagate through first aperture expander 208 in a first direction 252 away from coupling region 248.

In one example, reflectivity of first plurality of partially reflecting facets 242 may increase in a direction away from coupling region 248 to compensate for the decreased illumination that is transmitted by prior facets and ultimately reach terminal facet 258 that may be a mirror which only reflects illumination, and does not transmit illumination through the mirror. Alternatively, reflectivity of first plurality of partially reflecting facets 242 may be constant in a direction away from coupling region 248 until reaching terminal facet 258 that may be a mirror. When reflectivity of the facets is constant, each facet may have the same coating applied, for example. In yet another alternative, terminal facet 258 may have the same (e.g., uniform) partial reflectivity compared with the other partially reflecting facets 242 or terminal facet 258 may have a wedge configuration, in various applications. In this case, terminal facet 258 may not be a fully reflective mirror but may instead be a partially reflective element such as a partially reflective facet, wedge, and the like.

A leaky image pipe 220 may be disposed within waveguide 130 and may be configured to receive a first portion 224 of the first plurality of expanded image beams and provide a plurality of transmitted image beams 228. In this sense, leaky image pipe 220 may be considered embedded within waveguide 130. Leaky image pipe 220 may have the same or different index of refraction compared with the other components in waveguide 130. First portion 224 of plurality of expanded image beams 216 may be configured to partially reflect and propagate within leaky image pipe 220. In this manner, light beams may be transmitted through an inner surface 262 of leaky image pipe 220 along the path of light propagation to expand first portion 224 by partial reflection within leaky image pipe 220 and partial transmission of transmitted image beams 228 through inner surface 262 to obviate the need for more partially reflecting facets 242 in what would be a longer (e.g., taller) first aperture expander 208. In this manner, leaky image pipe 220 may transmit, reflect, and relocate (e.g., tunnel) rays that would have come from farther away. Expanding first portion 224 with leaky image pipe 220 may lead to a smaller waveguide having the same or better performance when compared with a larger waveguide having more partially reflecting facets, for example. Leaky image pipe 220 may be an elongated member having orthogonal sides and a rectangular cross section, thus having opposite and parallel surfaces configured to conserve the ray angles of propagation. In this manner, leaky image pipe 220 may have opposite sides that are parallel to each other with a rectangular cross section generally, or with a square cross section in one specific example.

Further, the reflective walls of leaky image pipe 220 may be orthogonal to the major surfaces of waveguide 130. In this manner, any ray coupled into leaky image pipe 220 may be coupled out from it with the exact same angle of propagation. Leaky image pipe 220 may be coated with various optical coatings such as varying reflective coatings, dielectric reflective coatings, highly reflective coatings, and the like. Leaky image pipe 220 may include an outer surface 260 that may be aligned or disposed parallel with a plane 206 that is perpendicular to front surface 202 corresponding to two of the three major axes (e.g., the X-Z plane) that may be used to describe the orientation of optical device 102 and/or waveguide 130, for example. As will be described more fully below, outer surface 260 of leaky image pipe 220 may also be aligned or disposed at an angle with horizontal axis 210. Hence, leaky image pipe 220 may be oriented at least one of perpendicular to front surface 202, oriented non-perpendicular to front surface 202, and oriented at an angle with horizontal axis 210, as illustrated.

Outer surface 260 of leaky image pipe 220 may further include a mirror 274 (e.g., a mirror coating) that is only reflecting illumination within leaky image pipe 220 and not transmitting light through outer surface 260. In this manner, illumination reflected within leaky image pipe 220 may be transmitted through inner surface 262 of leaky image pipe 220. More specifically, a first portion 224 of first plurality of expanded image beams 216 may enter an input face 264 (e.g., an input aperture 264) of leaky image pipe 220 and may be propagated as a plurality of reflected beams 230, where some portion of the reflected beams 230 may be transmitted through inner surface 262. While input aperture 264 may be described as an input face 264 for convenience, input aperture 264 may be practiced in various ways. For example, leaky image pipe 220 may be formed of an initially transparent slab having the same or a different refractive index from that of the remaining components of waveguide 130. In this example, leaky image pipe 220 having a different index of refraction may have an actual entrance aperture that may have a polished optical surface. Alternatively, when leaky image pipe 220 has the same index of refraction as other components of waveguide 130, input aperture 264 may be implemented as parallel but laterally separated coating layers. Input face 264 may be perpendicular to front surface 202 and inclined at an angle relative to outer surface 260 that may range between 20° and 160°, and may preferably range between 35° and 150°, and may typically be about 90°, as illustrated. In this manner, input face 264 may form an angle with illumination coming from first aperture expander 208 where the angle may range from an acute angle (e.g., angled away from first aperture expander 208 to capture less illumination) or an obtuse angle (e.g., angled toward first aperture expander 208 to capture more illumination). In this manner, an angle of input face 264 (e.g., an entrance pupil) may be used to set or control an amount of illumination captured by leaky image pipe 220 to balance illumination levels within waveguide 130, thus setting an effective aperture seen from an object side, for example. For completeness, some portion of reflected beams 230 may exit through an output face 266 of leaky image pipe 220, which may be negligible. Again, depending on the implementation, output face 266 may not be an optically polished surface. Instead, output face 266 may correspond to an ending region of parallel but laterally separated coatings, as described. In some examples, the lateral separation may be significant where some portion of the coating may be omitted when light transmitted and reflected by leaky image pipe 220 may not reach eye motion box 276 and the eye of a user. Mirror coating 274 on leaky image pipe 220 outer surface 260 may be omitted for regions of leaky image pipe 220 which are not needed to reflect image beams into eye motion box 276 for example. This may be beneficial both by saving the cost of applying a portion of the mirror coating, and by not unnecessarily obscuring a view of a user through the un-mirror portion of waveguide 130, for example.

A second aperture expander 232 may be disposed within waveguide 130 and configured to receive a second portion 236 of first plurality of expanded image beams 216 and plurality of transmitted image beams 228. Similar in some ways to first aperture expander 208, second aperture expander 232 may include a second plurality of partially reflecting facets 272 that are inclined at an angle that may be oblique relative to at least one of the front surface 202 and a plane 206 (e.g., an X-Z plane) that is perpendicular to the front surface. As illustrated, second portion of first plurality of expanded image beams 216 and plurality of transmitted image beams 228 may both be directed to second aperture expander 232 where the second plurality of expanded image beams 240 may be directed toward an eye of a user adjacent to eye motion box 276, for example. Thus, second aperture expander 232 may be configured to provide a second plurality of expanded image beams 240 configured to exit through (e.g., be transmitted through) rear surface 204. In this manner, first aperture expander 208 and second aperture expander 232 may cooperate to expand a version of collimated image beam 290 in two dimensions (2D), thus resulting in a two-dimensional expansion of input image beam 290 to an out-coupling region of waveguide 130, also described as an eye motion box 276, and configured to exit through rear surface 204 toward an eye 280 of a user.

Various light homogenizers (e.g., partially reflecting homogenizing layers) may also be used alone or in combination to provide improved image uniformity of intensity, among other benefits. For example, as shown in FIG. 2B, waveguide 130 may comprise a partial plane reflector as a first homogenizing layer 284, where the partial plane reflector as first homogenizing layer 284 may be disposed in a plane between the front surface 202 and the rear surface 204. Waveguide 130 may also comprise a second homogenizing layer 286 disposed in a plane between the front surface 268 and the rear surface 270 of the leaky image pipe 220. In this manner, second homogenizing layer 286 may be vertically oriented to homogenize light based on horizontal reflections. Leaky image pipe 220 may also comprise a third homogenizing layer 288 disposed in a plane between inner surface 262 and outer surface 260 of the leaky image pipe 220. In this manner, third homogenizing layer may be horizontally oriented to homogenize light based on vertical reflections. Third homogenizing layer 288 may be a semi-reflective surface added within leaky image pipe 220, such as a film disposed parallel to its reflective walls, such as to fill one or more empty slab apertures, for example. As illustrated, first portion 224 of first plurality of expanded image beams 216 may enter leaky image pipe 220 at an entrance aperture 264 and be partially reflected by third homogenizing layer 288 and partially transmitted to then be partially reflected by an interior side of leaky image pipe 220 inner surface 262. When present, second homogenizing layer 286 may double the beams by horizontally reflecting and propagating within leaky image pipe 220. When present, third homogenizing layer 288 may double the beams by vertically reflecting and propagating within leaky image pipe 220. This description also applies to other homogenizers disclosed herein.

Eye motion box 276 may be suitably illuminated due to illumination propagation 230 in leaky image pipe 220, increasing a field-of-view (FoV) for a user, obviating the need for a larger optical device, reducing size, reducing weight, and reducing costs. As described, FIGS. 2A-2B illustrate an optical system 100 (with an optical device 102) in a first configuration where second aperture expander 232 may be tilted toward first aperture expander 208, and where leaky image pipe 220 may be disposed vertically below second aperture expander 232, or second aperture expander 232 is disposed on top of leaky image pipe 220 (e.g., the light guiding slab), as illustrated. This is not considered limiting. With this example, and others, waveguide 130 may be rotated in a plane or flipped about a central or diagonal axis without departing from the disclosure.

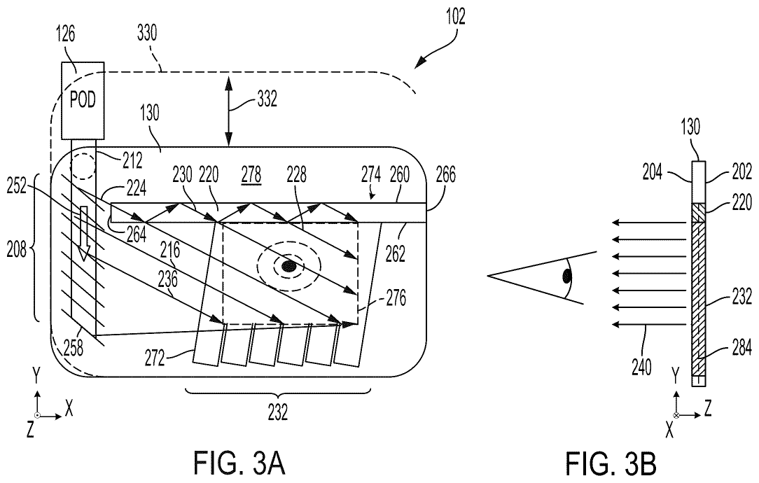

FIG. 3A illustrates a front plan view of an optical system including a waveguide, in accordance with various examples. FIG. 3B illustrates a side plan view of an optical system including the waveguide of FIG. 3A, in accordance with various examples. With further reference to FIG. 1 and FIGS. 2A-2B, together these illustrate an optical system 100 (with an optical device 102) in a second configuration where second aperture expander 232 may be tilted toward first aperture expander 208, and where leaky image pipe 220 may be disposed vertically above second aperture expander 232. In this manner, the illustration of FIGS. 3A-3B this second configuration may be considered to be “flipped” vertically in reference to the illustration of FIGS. 2A-2B described above. This is not considered limiting, and references such as outer surface 260 and inner surface 262 may be easily understood to be relative terms which could also be identified as first surface 260 and second surface 262 disposed opposite from first surface 260, and vice versa, without departing from the disclosure. As with the size, weight, and cost savings illustrated by the example of FIGS. 2A-2B, the example of FIGS. 3A-3B also illustrate a relative size reduction that may be possible compared with a larger waveguide 330 having a larger profile and increased height 332, as compared with FIG. 2A, for example.

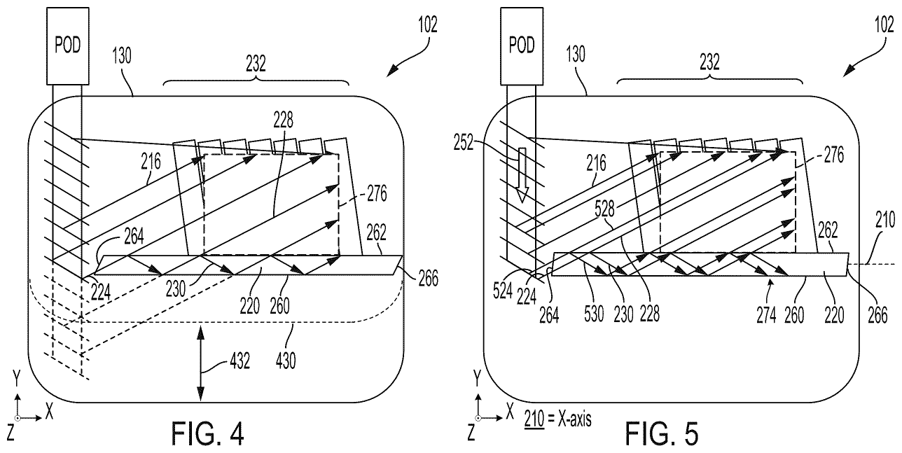

FIG. 4 illustrates a front plan view of an optical system including a waveguide, in accordance with various examples. Based on the foregoing descriptions of FIGS. 2A-2B, the example illustrated in FIG. 4 includes input face 264 that may be perpendicular to front surface 202 and inclined at an angle relative to outer surface 260 that may range between 20° and 160°. In this example, input face 264 may form an acute angle (e.g., angled away from first aperture expander 208 to capture less illumination and reflect more illumination), as illustrated. Input face 264 may be angled the same (e.g., same direction and same angle) as output face 266, but this is not considered limiting. Similar in some ways to the example of FIG. 2A and FIG. 3A, a first portion 224 of first plurality of expanded image beams 216 may enter an input face 264 of leaky image pipe 220 and may be propagated as a plurality of reflected beams 230, where some portion of the reflected beams 230 may be transmitted through inner surface 262. FIG. 4 illustrates a plurality of representative, phantom reflected image beams corresponding to transmitted image beams 228 from leaky image pipe 220 as if the corresponding transmitted image beams had been reflected by partially reflecting facets in a representation of an extended first aperture expander 208 having an increased number of partially reflecting facets. In this manner, use of leaky image pipe 220 may allow a reduction in the size and/or profile waveguide 130 to be implemented as a smaller waveguide 430 having a reduced height 432.

FIG. 5 illustrates a front plan view of an optical system including a waveguide, in accordance with various examples, In reference to FIG. 1 and FIGS. 2A-2B along with FIG. 5, an optical device 102 may include a leaky image pipe 220 that may have an outer surface 260 that may not be oriented perpendicular to front surface 202. Instead, outer surface 260 may be rotated about horizontal axis 210 so that outer surface 260 is angled to reflect illumination toward rear surface 204 and second aperture expander 232, for example. Alternatively, outer surface 260 may be rotated about horizontal axis 210 so that outer surface 260 is angled to reflect illumination toward front surface 202 where the illumination directed toward front surface 202 may be reflected back towards second aperture expander 232, for example. In this manner, leaky image pipe 220 may receive first portion 224 of first plurality of expanded image beams 216 and at least one more beam 524 at entrance aperture 264 so that both first portion 224 and at least one more beam 524 may both be reflected and propagated within leaky image pipe 220. In this manner, first portion 224 may provide a transmitted beam 228 that may be transmitted through inner surface 262 toward eye motion box 276 and a reflected beam 230 within leaky image pipe 220. Similarly, at least one more beam 524 may provide a transmitted beam 528 that may be transmitted through inner surface 262 toward eye motion box 276 and at least one reflected beam 530 that may be reflected within leaky image pipe 220, as described above. While only representative beams are illustrated in FIG. 5 and elsewhere, it is understood that many other image beams will be received, transmitted, reflected, and propagated in a practical implementation.

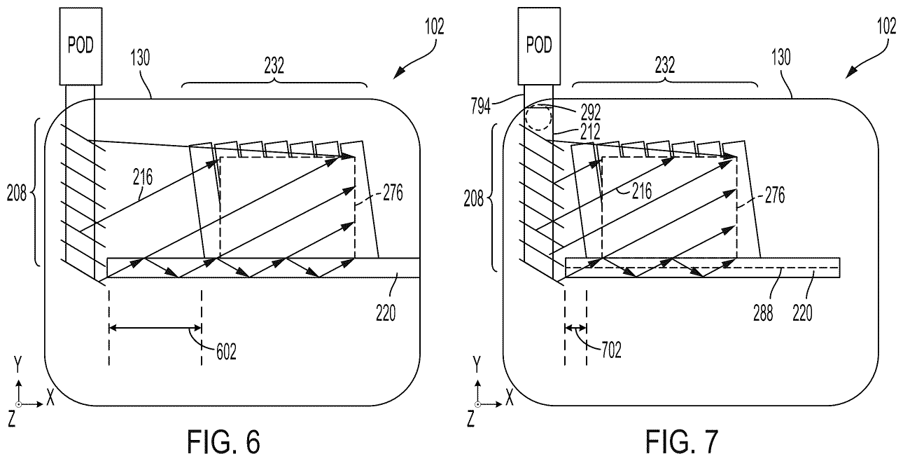

FIG. 6 illustrates a front plan view of an optical system including a waveguide, in accordance with various examples. Similar in some ways to the example illustrated in FIGS. 2A-2B, FIG. 6 illustrates a waveguide 130 having a separation distance 602 between first aperture expander 208 and second aperture expander 232 where separation distance 602 provides a gap between first aperture expander 208 and second aperture expander 232 which may be utilized to place eye motion box 276 farther from first aperture expander, for example.

FIG. 7 illustrates a front plan view of an optical system including a waveguide, in accordance with various examples. Similar in some ways to the example illustrated in FIGS. 2A-2B and FIG. 6 above, FIG. 7 illustrates a waveguide 130 having a separation distance 702 between first aperture expander 208 and second aperture expander 232 where separation distance 702 may be less than distance 602 due to the addition of a fifth homogenizing layer 794 (e.g., fifth mixer 794) disposed between the image projector 126 and input coupler 292, where this configuration may allow a smaller form factor by pre-homogenizing the image beams thereby enabling a reduction in the separation distance between first aperture expander 208 and second aperture expander 232 so that leaky image pipe 220 may be juxtaposed adjacent to facets of first aperture expander 208. In comparison, the configuration illustrated in FIG. 7 may provide for a more compact (e.g., smaller) waveguide 130 based on the relatively smaller separation distance 702 to reduce a gap between first aperture expander 208 and second aperture expander 232 which may be utilized to place eye motion box 276 closer first aperture expander 208 leading to a smaller profile for waveguide 130, for example.

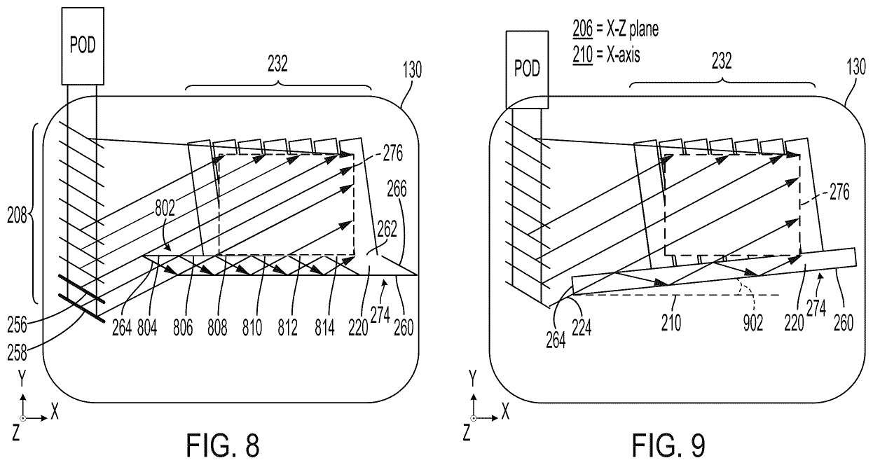

FIG. 8 illustrates a front plan view of an optical system including a waveguide, in accordance with various examples. Similar in some ways to the example illustrated in FIGS. 2A-2B, FIG. 8 illustrates an example of leaky image pipe 220 including an input face 264, an output face 266, and an inner surface 262 (e.g., a transmitting surface where reflected image beams may exit) which may have a coating 802 that is either uniformly transmissive with a same transmissivity across the surface or inner surface 262 may have a progressively transmissive coating applied in a direction from input face 264 to output face 266. In this sense, inner surface 262 may have a uniformly transmissive coating. As illustrated a progressively transmissive coating may allow an increasing amount of illumination to be transmitted through inner surface 262 based on an increasing linear distance from input face 264. Stated differently, coating 802 may be decreasingly reflective to allow a greater percentage of light energy to be transmitted through inner surface 262 based on a distance from input face 264. The increasing transmissivity of the coating 802 (corresponding to a decreasing reflectivity) may follow a continuous, gradual slope or a gradient of higher reflectivity at input face 264 toward a lower reflectivity at output face 266. In this sense, inner surface 262 may have a continuously progressive transmissive coating in a direction from input face 264 to output face 266. Alternatively, transmissive coating 802 may include a discrete, step-wise, or stair-step increase in transmissivity (e.g., or a corresponding discrete or step-wise decrease in reflectivity) based on adjacent, discrete coating regions including a first coating region 804 having a mirror coating (e.g., fully reflective) on a first region of inner surface 262 directed toward an interior region of leaky image pipe 220 and mirror 274 on outer surface 260 to form the input aperture 264 so that no illumination may be transmitted through first coating region 804. Next, progressively transmissive coating 802 may include a second coating region 806 at a second linear distance which is more transmissive than the mirror coating on a portion of inner surface corresponding to first coating region 804.

Similarly, progressively transmissive coating 802 may include a third coating region 808 at a third linear distance which is even less reflective and more transmissive. This pattern may continue for fourth coating region 810 being more transmissive than third coating region 808 but less transmissive than fifth coating region 812. Finally, sixth coating region 814 may be the most transmissive region of progressively transmissive coating 802 to allow any remaining illumination to be transmitted through inner surface 262, if not already depleted. In this sense, inner surface 262 may have a discretely progressive transmissive coating in a direction from input face 264 to output face 266. In this manner, an amount of illumination provided by reflected image light within leaky image pipe 220 may be controlled and balanced prior to coupling to out-coupling region of eye motion box 276. Progressively transmissive coating 802 may be applied as the same reflective and/or transmissive material applied multiple times for greater reflectivity and lower transmissivity, or different coating material may be used for each region. Penultimate facet 256 and ultimate (e.g., terminal) facet 258 at the end of first aperture expander 208 may similarly include greater reflectivity and lower transmissivity for facet 256 compared with facet 258 in order to ensure a maximum amount of illumination is redirected into leaky image pipe 220. In this example, the coating that forms outer surface 260 may be shortened (e.g., omitted at an initial portion) to enable filing of the input aperture 264. While these terms may be used together, input aperture 264 may also be defined as the vertical region between the inner surface 262 and the outer surface 260 that is adjacent to the portion of leaky image pipe 220 on a left-side (as illustrated) where outer surface 260 mirror coating 274 begins.

As described, image illumination may be injected into leaky image pipe 220 to fill first face 264. In one example, using only one single reflective coating may generate non-uniform illumination within eye motion box 276. To address this, multiple or varying coatings may be used where the reflectance is decreasing (e.g., fewer layers of impedance or reflective coating so transmission is increasing) across the out-coupling region of eye motion box 276, leading to more uniform illumination across eye motion box 276. Corresponding high-reflectance coatings may be added to first aperture expander facets 256 and 258 to ensure sufficient light power is injected into leaky image pipe 220 to achieve more uniform illumination.

FIG. 9 illustrates a front plan view of an optical system including a waveguide, in accordance with various examples. Similar in some ways to the example illustrated in FIGS. 2A-2B, FIG. 9 illustrates an example of leaky image pipe 220 aligned at an angle 902 with horizontal axis 210. Angle 902 may provide more freedom to an optical designer by providing more flexibility in the design of various coatings as well as to improve area usage such as freeing up a portion of waveguide 130 that may have been previously covered by a portion of leaky image pipe 220 in a horizontal orientation. The angle 902 may vary from between 0° to 30°, and preferably may vary between 15° to 20°.

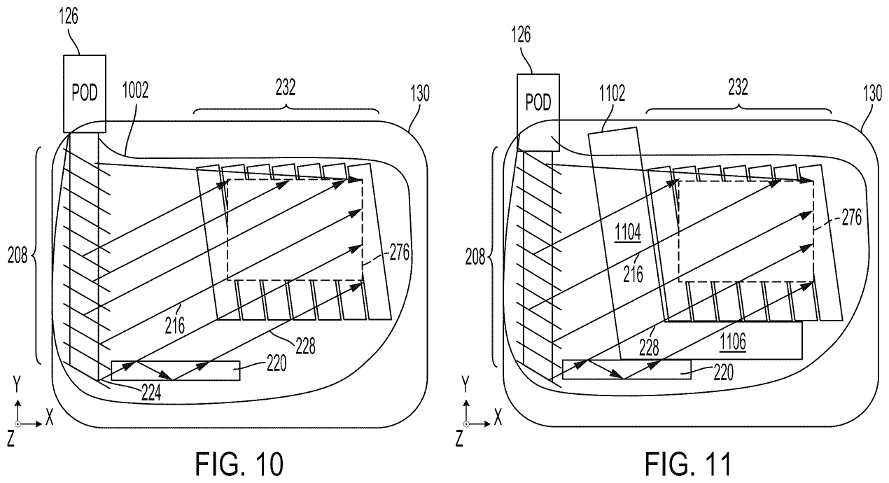

FIG. 10 illustrates a front plan view of an optical system including a waveguide, in accordance with various examples. Similar in some ways to the example illustrated in FIGS. 2A-2B, FIG. 10 illustrates an example of a significantly shorter and laterally displaced leaky image pipe 220, and disposed relatively close to first aperture expander 208 and relatively far from second aperture expander 232. As described above, illumination exiting from leaky image pipe 220 (e.g., illumination transmitted through inner surface 262) may illuminate corner regions of eye motion box 276 to provide illumination by transmitted image beams 228 that are spaced-apart or expanded, as above. FIG. 10 also illustrates a contour 1002 which may indicate an outline of a waveguide (WG) for use in a fashion eyeglass frame. In this manner, leaky image pipe 220 may be at least partially hidden within a portion of a frame 138 supporting waveguide 130, for example.

FIG. 11 illustrates a front plan view of an optical system including a waveguide, in accordance with various examples. Similar in some ways to the example of FIG. 10, the example of FIG. 11 includes the addition of a homogenizing layer 1102 having a first portion 1104 that is disposed between the first aperture expander 208 and the second aperture expander 232 and a second portion 1106 disposed between the leaky image pipe 220 and the second aperture expander 232. Homogenizing layer 1102 may be considered an L-shaped homogenizing region which may be a combination of a first homogenizing region 1104 connected with second homogenizing region 1106 as a single, continuous partially reflecting layer (e.g., parallel with front surface 202), or as an assembly of two or more regions to provide additional homogenizing of first plurality of expanded image beams 216 and provide mixing of illumination (e.g., radiation) directly from first aperture expander 208 in homogenizing layer section 1104 and illumination propagated from leaky image pipe 220 in homogenizing layer section 1106.

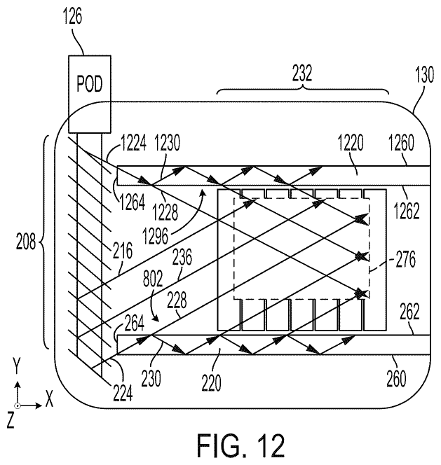

FIG. 12 illustrates a front plan view of an optical system including a waveguide, in accordance with various examples. Similar in some ways to the descriptions of various examples above, FIG. 12 illustrates an example waveguide 130 having a first leaky image pipe 220 disposed on a first side (e.g., a bottom side) of second aperture expander 232 and a second leaky image pipe 1220 disposed on a second side (e.g., a top side) of second aperture expander 232, when oriented vertically as illustrated. As described, a first portion 224 of first plurality of expanded image beams 216 from first aperture expander 208 may enter a first entrance aperture 264 to be partially transmitted as a plurality of first transmitted image beams 228 through a first inner surface 262 of first leaky image pipe 220 disposed adjacent to a bottom side of second aperture expander 232. Inner surface 262 may have a coating 802 that is one of a continuously progressive transmissive coating in a direction from input face 264 to output face 266, a discretely progressive transmissive coating in a direction from input face 264 to output face 266, and a uniformly transmissive coating. In this manner, first portion 224 of first plurality of expanded image beams 216 may exit the first leaky image pipe as an expanded beam towards the second aperture expander 232. First portion 224 of first plurality of expanded image beams 216 may be partially reflected within first leaky image pipe 220 as a plurality of first reflected image beams 230 reflecting within first leaky image pipe 220 from an interior side of a first outer surface 260 disposed on a side of first leaky image pipe 220 away from second aperture expander 232. Similarly, a third portion 1224 of first plurality of expanded image beams 216 from first aperture expander 208 may enter a second entrance aperture 1264 to be partially transmitted as a plurality of second transmitted image beams 1228 through a second inner surface 1262 of second leaky image pipe 1220 disposed adjacent to a top side of second aperture expander 232, as illustrated. As before, inner surface 1262 may have a coating 1296 that is one of a continuously progressive transmissive coating in a direction from input face 1264 to output face 1266, a discretely progressive transmissive coating in a direction from input face 1264 to output face 1266, and a uniformly transmissive coating. In this manner, third portion 1224 of first plurality of expanded image beams 216 may exit the second leaky image pipe as an expanded beam towards the second aperture expander 232. Third portion 1224 of first plurality of expanded image beams 216 may be partially reflected within second leaky image pipe 1220 as a plurality of reflected image beams 1230 reflecting within second leaky image pipe 1220 from an interior side of a second outer surface 1260 disposed on a side of second leaky image pipe 1220 away from second aperture expander 232. A remaining portion of expanded image beams 216 may be combined with plurality of first transmitted image beams 228 and plurality of second transmitted image beams 1228 and applied to second aperture expander 232 and directed to an eye of a user toward an eye motion box 276, as described with reference to FIG. 2A and FIG. 3A, for example. In this manner, second aperture expander 232 may receive the first plurality of transmitted image beams 228, the second plurality of transmitted image beams 1228, and the second portion 236 of the first plurality of expanded image beams 216 and provide a second plurality of expanded image beams 240 configured to exit through rear surface 204. In this example, first leaky image pipe 220 and second leaky image pipe 1220 may receive and process opposite beam directions to avoid generating a ghost image.

Various features described separately above may be combined together unless they are incompatible with each other. For example, either or both of the first leaky image pipe 220 and second leaky image pipe 1220 illustrated in FIG. 12 may be replaced by the leaky image pipe 220 that is aligned at an angle 902 with horizontal axis 210 as in the example described in reference to FIG. 9. Further, either or both of first leaky image pipe 220 and second leaky image pipe may include one or more homogenizers such as homogenizing layer 286 and homogenizing layer 288 described in reference to FIG. 2A-FIG. 2B.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Also, terms such as top, bottom, vertical, horizontal, fore, aft, inner, outer, and the like may describe relative placement of elements in a particular view illustrated in the drawings and should not be considered limiting. Such terminology may be applied oppositely when a view or element is inverted, for example.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The various embodiments were chosen and described in order to best explain the principles of the invention and the practical application, and to enable others of ordinary skill in the art to understand the invention for various embodiments with various modifications as are suited to the particular use contemplated.

1. An optical device comprising:
a waveguide having a front surface and a rear surface that are parallel to each other;
a coupling region disposed within the waveguide, configured to receive an input image beam, and configured to output the input image beam into the waveguide;
a first aperture expander disposed within the waveguide and comprising a first plurality of partially reflecting facets that are planar, disposed between the front surface and the rear surface, parallel to each other, and non-parallel to the front surface and the rear surface, and configured to receive the input image beam from the coupling region and provide a first plurality of expanded image beams, that propagate and reflect between the front surface and the rear surface, wherein:
a first portion of the first plurality of partially reflecting facets that are away from the coupling region is configured to produce a first portion of the first plurality of expanded image beams; and
a second portion of the first plurality of partially reflecting facets that are proximate the coupling region is configured to produce a second portion of the first plurality of expanded image beams;
a leaky image pipe formed within the waveguide and configured to receive the first portion of the first plurality of expanded image beams, cause, via one or more reflecting surfaces of the leaky image pipe, the first portion of the first plurality of expanded image beams to reflect within the leaky image pipe, and provide, via at least one partially reflecting surface of the leaky image pipe, a plurality of transmitted image beams to the second aperture expander; and
a second aperture expander disposed within the waveguide and configured to receive the second portion of the first plurality of expanded image beams and the plurality of transmitted image beams, and provide a second plurality of expanded image beams that exit the waveguide through the rear surface.

2. The optical device of claim 1,
wherein the leaky image pipe includes an output face and an inner surface, and
wherein:
the inner surface has a continuously progressive transmissive coating in a direction from the input face to the output face;
the inner surface has a discretely progressive transmissive coating in a direction from the input face to the output face; or
the inner surface has a uniformly transmissive coating.

3. (canceled)

4. The optical device of claim 1,
wherein the input image beam propagates through the first aperture expander in a first direction away from the coupling region, and
wherein:
a reflectivity of the first plurality of partially reflecting facets increases in the first direction;
a reflectivity of the first plurality of partially reflecting facets is constant in the first direction away;
the first aperture expander has a terminal facet that is a partially reflecting facet; or
the first aperture expander has a terminal facet that is a mirror.

5. The optical device of claim 1,
wherein the leaky image pipe is an elongated member having orthogonal sides a rectangular cross section, and
wherein the leaky image pipe has an outer surface that is:
aligned perpendicular to the front surface;
aligned non-perpendicular to the front surface; or
aligned at an angle with a horizontal axis of the waveguide.

6. The optical device of claim 5, wherein the leaky image pipe further comprises an outer surface with a mirror disposed on a side of the leaky image pipe opposite the second aperture expander.

7. The optical device of claim 1, wherein:
the leaky image pipe further comprises an outer surface; and
the input face is perpendicular to the front surface and inclined between 20° and 160° relative to the outer surface.

8. The optical device of claim 1, wherein:
the leaky image pipe is a first leaky image pipe;
the plurality of transmitted image beams is a first plurality of transmitted image beams;
the input face is a first input face;
the at least one partially reflecting surface is a first at least one partially reflecting surface;
a third portion of the first plurality of partially reflecting facets is configured to produce a third portion of the first plurality of expanded image beams and provide the third portion of the first plurality of expanded image beams to a second leaky image pipe;
the optical device further comprises the second leaky image pipe disposed within the waveguide on a side of the second aperture expander opposite the first leaky image pipe and configured to receive the third portion of the first plurality of expanded image beams and provide, via a second at least one partially reflecting surface of the second leaky image pipe, a second plurality of transmitted image beams to the second aperture expander; and
the second aperture expander is further configured to receive the second plurality of transmitted image beams,

9. The optical device of claim 8, wherein the first leaky image pipe or the second leaky image pipe is disposed at an angle relative to a horizontal axis of the waveguide.

10. The optical device of claim 1, wherein the second aperture expander comprises a second plurality of partially reflecting facets that are planar, disposed between the front surface and the rear surface, parallel to each other, and oblique to the front surface or a plane that is perpendicular to the front surface.

11. The optical device of claim 1, wherein the second plurality of expanded image beams are directed to an eye motion box.

12. The optical device of claim 1, wherein the waveguide further comprises a homogenizing layer disposed in a plane between the front surface and the rear surface.

13. The optical device of claim 1, wherein the leaky image pipe further comprises a homogenizing layer disposed in a plane between the front surface and the rear surface of the leaky image pipe.

14. The optical device of claim 1, wherein the leaky image pipe further comprises a homogenizing layer disposed in a plane between an inner surface and an outer surface of the leaky image pipe.

15. The optical device of claim 1, wherein the leaky image pipe further comprises a homogenizing layer having:
a first portion that is disposed between the first aperture expander and the second aperture expander; and
a second portion disposed between the leaky image pipe and the second aperture expander.

16. The optical device of claim 1, further comprising:
an image projector configured to produce, based on a digital image, the input image beam collimated to infinity;
an input coupler configured to receive the input image beam and provide the input image beam to the coupling region; and a homogenizing layer disposed between the image projector and the input coupler.

17. An optical system comprising:
a waveguide having a front surface and a rear surface that are parallel to each other;
an image projector configured to produce, based on a digital image, a collimated image beam collimated to infinity;
an input coupler configured to receive the collimated image beam and output an input image beam into the waveguide at a coupling region;
a first aperture expander disposed within the waveguide and comprising a first plurality of partially reflecting facets that are planar, disposed between the front surface and the rear surface, parallel to each other, and non-parallel to the front surface and the rear surface, and configured to receive the input image beam from the coupling region and provide a first plurality of expanded image beams that propagate and reflect between the front surface and the rear surface, wherein:
a first portion of the first plurality of partially reflecting facets that are away from the coupling region is configured to produce a first portion of the first plurality of expanded image beams; and
a second portion of the first plurality of partially reflecting facets that are proximate the coupling region is configured to produce a second portion of the first plurality of expanded image beams;
a leaky image pipe formed within the waveguide and configured to receive the first portion of the first plurality of expanded image beams, cause, via one or more reflecting surfaces of the leaky image pipe, the first portion of the first plurality of expanded image beams to reflect within the leaky image pipe, and provide, via at least one partially reflecting surface of the leaky image pipe, a plurality of transmitted image beams to the second aperture expander; and
a second aperture expander disposed within the waveguide and configured to receive the second portion of the first plurality of expanded image beams and the plurality of reflected image beams and provide a second plurality of expanded image beams that exit the waveguide through the rear surface.

18. The optical system of claim 17,
wherein the leaky image pipe includes an output face and an inner surface, and
wherein:
the inner surface has a continuously progressive transmissive coating in a direction from the input face to the output face;
the inner surface has a discretely progressive transmissive coating in a direction from the input face to the output face; or
the inner surface has a uniformly transmissive coating.

19. (canceled)

20. The optical system of claim 17, wherein:
the leaky image pipe further comprises an outer surface with a mirror disposed perpendicular to the front surface, the outer surface and mirror being disposed on a side of the leaky image pipe opposite the second aperture expander; and
the input face is perpendicular to the front surface and inclined between 20° and 160° relative to the outer surface.

21. A waveguide comprising:
a front surface and a rear surface that are parallel to each other;
a first aperture expander comprising a first plurality of partially reflecting facets that are planar, disposed between the front surface and the rear surface, parallel to each other, and non-parallel to the front surface and the rear surface, and configured to receive an input image beam and provide a first plurality of expanded image beams that propagate and reflect between the front surface and the rear surface, wherein:
a first portion of the first plurality of partially reflecting facets is configured to produce a first portion of the first plurality of expanded image beams; and
a second portion of the first plurality of partially reflecting facets is configured to produce a second portion of the first plurality of expanded image beams;
a leaky image pipe configured to receive the first portion of the first plurality of expanded image beams, cause, via one or more reflecting surfaces of the leaky image pipe, the first portion of the first plurality of expanded image beams to reflect within the leaky image pipe, and provide, via at least one partially reflecting surface of the leaky image pipe, a plurality of transmitted image beams to the second aperture expander; and
a second aperture expander configured to receive the second portion of the first plurality of expanded image beams and the plurality of transmitted image beams and provide a second plurality of expanded image beams that exit the waveguide through the rear surface.
